(19) United States
(12) Patent Application Publication
(10) Pub. No.: US 2022/0014558 A1
(43) Pub. Date: Jan. 13, 2022

(54) INFORMATION SECURITY MANAGEMENT SYSTEM

(71) Applicant: UPAS CORPORATION, Taipei (TW)

(72) Inventor: KUN-JUNG LEE, Taipei (TW)

(21) Appl. No.: 17/224,795

(22) Filed: Apr. 7, 2021

(30) Foreign Application Priority Data
Jul. 9, 2020 (TW) 109123162

(51) Int. Cl. H04L 29/06

(52) U.S. Cl. CPC H04L 63/20; H04L 63/102; H04L 63/0236; H04L 63/0876

(57) ABSTRACT

An information security management system comprises a data collecting unit, an integrating analyzing unit, a regulation inspecting unit and a network blocking unit for integrating information security database data of a plurality of third-party management consoles. When an endpoint device is not in conformity with information security policy, the information security management system of the present invention could block the endpoint device from network communication with the network environment to enhance the security of the endpoint device.

### FIELD OF THE INVENTION

The present invention relates to an endpoint security system, and more particularly relates to an information security management system.

### BACKGROUND OF THE INVENTION

Information security is a fundamental and important factor for ensuring success of incorporation. The importance of information security for incorporation has been more and more emphasized. When various aspects of information security are considered, there are several different types of information security software which could be chosen, such as antivirus software and data backup management software. In addition, incorporation may purchase the information security software from different software providers, and therefore, in the situation where different software providers are coexisted in a system, each type of information security software is generally collectively managed by a third-party management console to which the information security software belongs.

With an increase of different types of software deployed, a problem of data-not-integrated occurs, since each type of information software only provides data in relation to itself.

For example, an updating operation of information security software, which is performed for fixing bugs existing in the previous version, is always required to ensure safety of the latest information security software installed in the endpoint device so as to reduce the internet attacks from outside. However, in the above scenario, since these data are not integrated, the system administrator has to log in all of the third-party management consoles to check whether each of the information security software has been updated. Therefore, it becomes a hassle for system administrator. In addition, it causes a huge threat to information security if information security software is ignored to be updated for a long time no matter by the reason of users' or administrators' carelessness or the support from the developer being stopped.

### SUMMARY OF THE INVENTION

Accordingly, one objective of the present invention is to provide an information security management system having functionally of capable of integrating data for multiple types of information security software installed in a plurality of different endpoint devices. It thus makes the work of administrator management easier and more efficient.

In order to overcome the technical problems in prior art, the present invention provides an information security management system that is applied to perform information security managing operation for multiple types of information security software installed in a plurality of endpoint devices existing in a network environment where each endpoint device is installed with at least one type of information security software, wherein one type of the information security software is correspondingly managed and controlled by one third-party management console in such a manner that one endpoint device is connected to the third-party management console to which the type of the information security software installed in said one endpoint device corresponds, the information security management system comprising: a data collecting unit configured to collect information security database data from third-party software databases of the plurality of third-party management consoles, wherein the information security database data includes endpoint device address data and information security software data of the endpoint device to which the third-party management console connect; an integrating analyzing unit connecting to the data collection unit, the integrating analyzing unit being configured to integrate the information security information security database data to create an integrated management list, the integrated management list containing the endpoint device address data and the information security software data; a regulation inspecting unit connecting to the integrating analyzing unit, the regulation inspecting unit being configured to inspect whether the information security software data of each endpoint devices in the integrated management list is in conformity with a predetermined information security policy, and accordingly create a violation list containing the endpoint device address data of the endpoint device not in conformity with the predetermined information security policy; and a network blocking unit connecting to the regulation inspecting unit, the network blocking unit being configured to corresponding block the endpoint device from the network environment according to the endpoint device address data in the violation list.

In one embodiment of the present invention, the violation list comprises violation time period data, and the network blocking unit applies a network blocking mode according to the violation time period data to block the corresponding endpoint device from network communication with the network environment.

In one embodiment of the present invention, the network blocking mode comprises a permanent blocking mode and an interference blocking mode.

In one embodiment of the present invention, the regulation inspecting unit periodically inspects to confirm whether each endpoint device in the integrated management list is in conformity with the predetermined information security policy.

In one embodiment of the present invention, the network blocking unit blocks the endpoint device from network communication with the network environment for a blocking time period which is shorter than a block-inspecting time interval between two periodic block inspecting operations applied to the endpoint device in the violation list performed by the network blocking unit.

In one embodiment of the present invention, the endpoint device address data comprises an IP address and/or a MAC address.

In one embodiment of the present invention, the information security software data comprises information security software version data, the regulation inspecting unit inspects the information security software version data to confirm whether the information security software version data is in conformity with the information security policy.

With the technical means adopted by the present invention, the information security database information from a plurality of third-party information security management consoles can be integrated in the information security management system such that the matter that whether all endpoint devices are in conformity with the predetermined information security policy could be inspected by enabling the system administrator being not required to go to the plurality of third-party information security management consoles for inspection. Furthermore, when a specific endpoint device is not in conformity with the information security policy, the network blocking unit could block the endpoint device from the network environment so as to protect the fragile link of information security from external threats to improve the security of the plurality of endpoint devices.

### BRIEF DESCRIPTION OF THE DRAWINGS

FIG. 1 is a schematic block diagram illustrating an information security management system according to one embodiment of the present invention;

FIG. 2 is a schematic diagram illustrating a network environment in which the information security management system is applied according to the embodiment of the present invention;

FIG. 3 is a flowchart of the information security management system according to the embodiment of the present invention;

FIG. 4 is a flowchart of a regulation inspecting unit of the information security management system inspecting each endpoint devices according to one embodiment of the present invention; and

FIG. 5 is a flowchart of a network blocking unit of the information security management system performing network blocking according to one embodiment of the present invention.

### DETAILED DESCRIPTION OF THE PREFERRED EMBODIMENTS

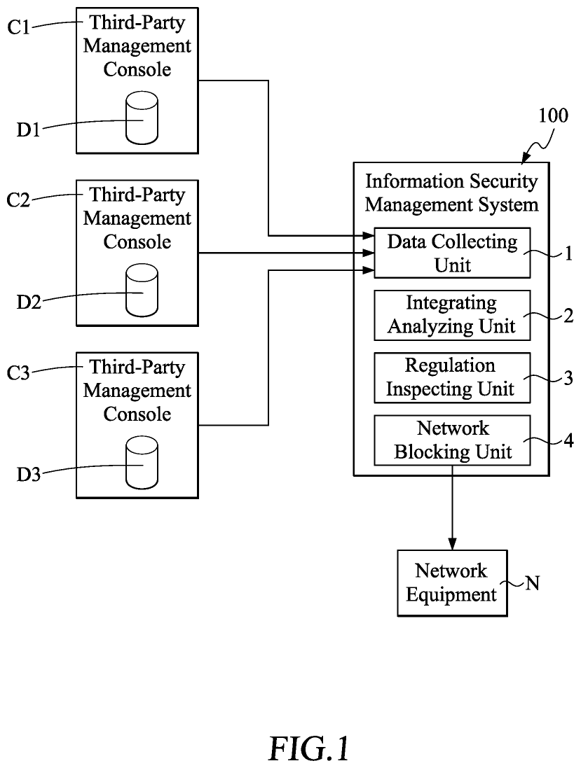

The preferred embodiments of the present invention are described in detail below with reference to FIG. 1 to FIG. 5. The description is used for explaining the embodiments of the present invention only, but not for limiting the scope of the claims.

As shown in FIG. 1, an information security management system according to one embodiment of the present invention includes: a data collecting unit 1, an integrating analyzing unit 2, a regulation inspecting unit 3 and a network blocking unit 4.

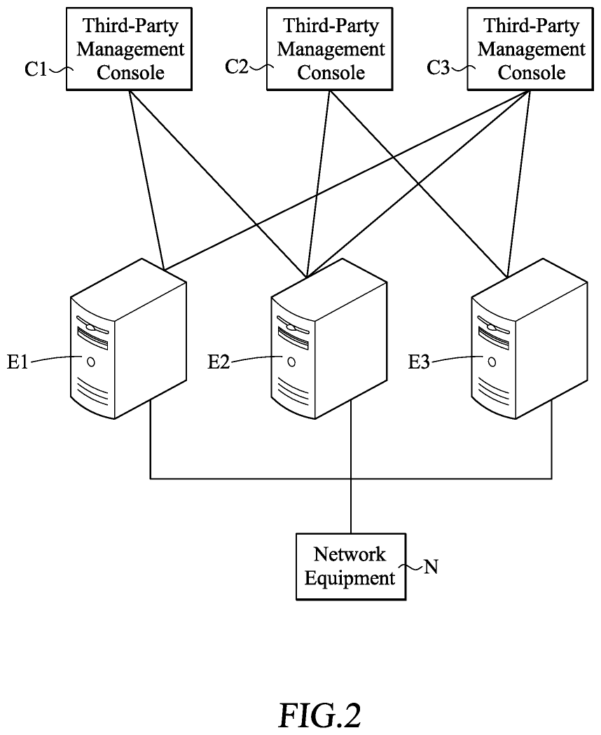

As shown in FIG. 1 and FIG. 2, the information security management system 100 is applied to perform information security managing operation for multiple types of information security software installed in a plurality of endpoint devices E1, E2, E3 existing in a network environment where each endpoint device E1, E2, E3 is installed with at least one type of information security software, wherein the network environment is a company-wide intranet. The information security software can be software having function such as anti-virus, firewall, asset management, e-mail protection, intrusion detection, or identity and access management, or a software suite having multiple functions afore-mentioned.

One type of the information security software is correspondingly managed and controlled by one third-party management console. In this embodiment, as shown in FIG. 2, there are three third-party management consoles C1, C2, C3 which control three types of information security software in total installed in the endpoint devices E1, E2, E3. The third-party management console C1 controls the first type of information security software. The third-party management console C2 controls the second type of information security software. The third-party management console C3 controls the third type of information security software.

One endpoint device E1, E2, E3 is to the one third-party management console C1, C2, C3 to which the type of the information security software installed in said one endpoint device E1, E2, E3 corresponds. For example, as shown in FIG. 1, the endpoint device E1 installed with the first type and the third type of information security software is connected to the third-party management consoles C1, C3. The endpoint device E2 installed with the first type, the second type and the third type of information security software is connected to the third-party management consoles C1, C2, C3. The endpoint device E3 installed with the first type and the second type of information security software is connected to the third-party management consoles C1, C2. Thereby, the third-party management console C1 can receive the endpoint device address data and information security software data of the endpoint devices E1, E2. The third-party management console C2 can receive the endpoint device address data and information security software data of the endpoint devices E2, E3. The third-party management console C3 can receive the endpoint device address data and information security software data of the endpoint devices E1, E2, E3. The third-party management consoles C1, C2, C3 store the received endpoint device address data and information security software data in their respective third-party software databases D1, D2, D3.

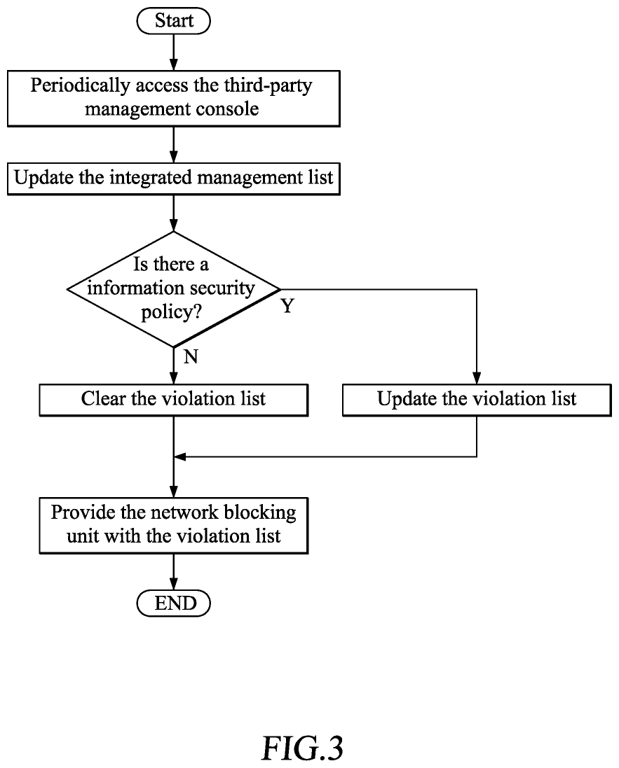

As shown in FIG. 1 to FIG. 3, the data collecting unit 1 is connected to all of the third-party management consoles C1, C2, C3 to collect the information security database data from the third-party software databases D1, D2, D3 of the third-party management consoles C1, C2, C3. The information security database data includes endpoint device address data and information security software data of the endpoint device to which the third-party management console connect. In this embodiment, as shown in FIG. 3, the data collecting unit 1 periodically accesses the third-party management consoles C1, C2, C3 to collect the endpoint device address data and the information security software data.

As shown in FIG. 1 to FIG. 3, depending on the source third-party management consoles C1, C2, C3, the endpoint device address data collected by the data collecting unit 1 does not necessarily contain only IP addresses or only MAC addresses, and it can contain both of them. For example, the endpoint device address data collected from the third-party management console C1 may contain IP addresses of the endpoint device E1, E2. The endpoint device address data collected from the third-party management console C2, C3 may contain MAC addresses of the endpoint device E1, E2, E3.

The integrating analyzing unit 2 is connected to the data collecting unit 1. The integrating analyzing unit 2 is configured to integrate the information security database data to create an integrated management list. The integrated management list contains the endpoint device address data and the information security software data. In detail, according to an IP and MAC address correspondence table, the integrating analyzing unit 2 integrates the endpoint device address data collected by the data collecting unit 1 to merge multiple entries of information security database data in relation to the same one endpoint device E1, E2, E3 into one entry. Therefore, the system administrator is not required to go to the plurality of third-party information security management consoles C1, C2, C3 one by one to inspect whether three types of the information security software of each endpoint device E1, E2, E3 comply with a predetermined information security policy.

In this embodiment, the endpoint device address data in the integrated management list is a combination of IP addresses and MAC addresses. In other embodiments, the endpoint device address data in the integrated management list contain only IP addresses or only MAC addresses.

In the integrated management list, each endpoint device E1, E2, E3 has corresponding information security software information. The information security software information may include: information security software name data, information security software version data, virus signature version data, and authorization data. The data fields of the information security database data may be dynamically added with the addition of the third-party software databases.

In addition, the integrated management list may further include computer name data, so as to facilitate the integration of the endpoint device address data and help the system administrator to identify the endpoint devices E1, E2, E3.

As shown in FIG. 1 and FIG. 3, according to the information security management system 100 of the embodiment of the present invention, the regulation inspecting unit 3 is connected to integrating analyzing unit 2. The regulation inspecting unit 3 periodically inspects whether the information security software data of each endpoint devices in the integrated management list is in conformity with a predetermined information security policy, and accordingly creates a violation list containing the endpoint device address data of the endpoint devices not in conformity with the predetermined information security policy

Information security policy is a collection of regulations for the security software information data. For example, the information security policy regulates that information security software version data has to be the latest version. The regulation inspecting unit 3 would inspect whether the information security software version data of all security software of each endpoint device E1, E2, E2 is the latest version. When the version of specific information security software of the endpoint device is not the latest version, the regulation inspecting unit 3 adds the endpoint device address data of violated endpoint device to the violation list.

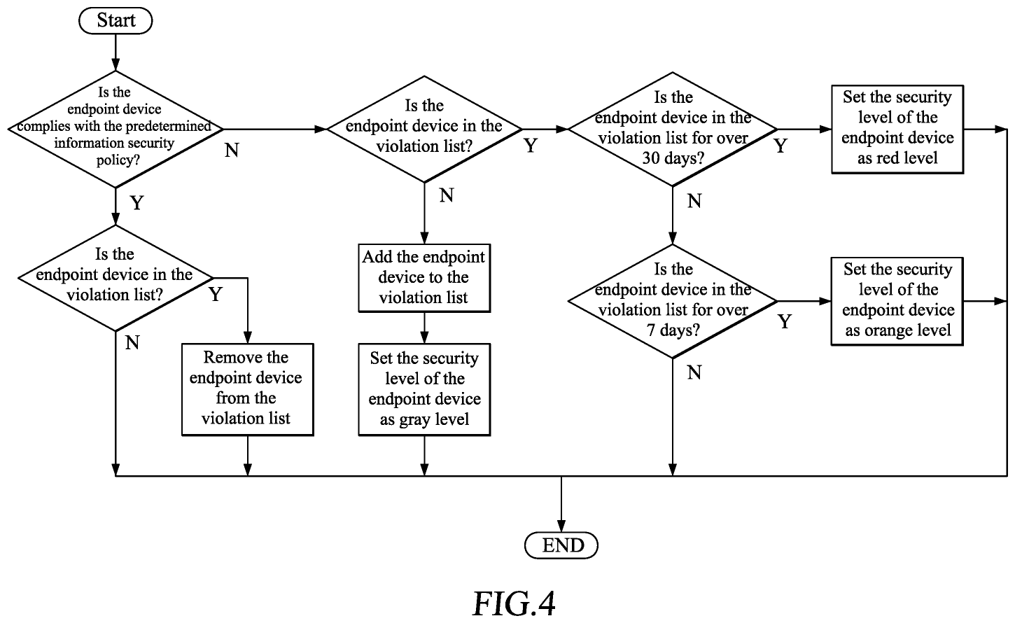

In this embodiment, the violation list also comprises violation time period data. As shown in FIG. 4, the violation time period of the violation time period data is categorized into three intervals: below 7 days, 7 days to 30 days, and over 30 days. The regulation inspecting unit 3 sets the security level of the endpoint devices that violate the regulation for below 7 days as gray level, the security level of the endpoint devices that violate the regulation between 7 days to 30 days as orange level, and the security level of the endpoint devices that violate the regulation for over 30 days as red level, making administrating the endpoint devices easier and more efficient. It goes without saying that the length and the number of the categories of violation time period are not limited to this, and the violation time period may be uncategorized.

As shown in FIG. 1 to FIG. 5, according to the information security management system 100 of the embodiment of the present invention, the network blocking unit 4 is connected to the regulation inspecting unit 3. The network blocking unit 4 is configured to corresponding block the endpoint device from the network environment according to the endpoint device address data in the violation list. In this embodiment, block inspecting operations of the network blocking unit 4 are performed periodically. The network blocking unit 4 applies a network blocking mode according to the violation time period data to block the corresponding endpoint device from network communication with the network environment. In other embodiments, the network blocking unit 4 may apply a corresponding network blocking mode according to severity of violation (for example, unmatched virus signature version data is severer than unmatched information security software version data) or other conditions to block the corresponding endpoint device from network communication with the network environment. Alternatively, the network blocking unit 4 may apply a single network blocking mode which immediate blocks the violated endpoint devices from network communication with the network environment no matter what condition (for example, violation time period) is it. The block inspecting operations of the network blocking unit 4 can also be performed immediately when endpoint device address data of the violated endpoint device is added to the violation list.

In this embodiment, the network blocking mode comprises a permanent blocking mode and an interference blocking mode. The permanent blocking mode is that the network blocking unit 4 permanently blocks the endpoint device from the network environment until the system administrator lifts the blockade, or the blockade could be lifted by the information security management system 100 when the endpoint devices E1, E2, E3 are in conformity with information security policy. The interference blocking mode is that the network blocking unit 4 blocks the endpoint device from network communication with the network environment for a blocking time period which is shorter than an block-inspecting time interval between two periodic block inspecting operations, and thus the violated endpoint device is periodically blocked from network communication with the network environment to remind and prompt the user of the endpoint device to troubleshoot. In an embodiment with only one network blocking mode, the network blocking mode can be either the permanent blocking mode or the interference blocking mode.

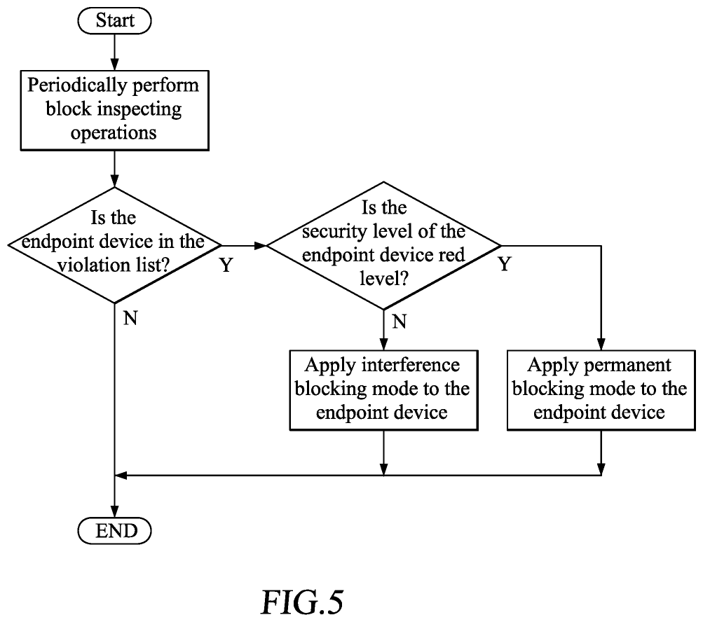

As shown in FIG. 5, the interference blocking mode is applied to the endpoint devices in the violation list when the violation time period thereof is below 30 days (orange or gray security level). A permanent blocking mode is applied to the endpoint devices in the violation list when the violation time period thereof is over 30 days (red security level). By applying the interference blocking mode prior to the permanent blocking mode, it gives the user of the violated endpoint device enough time to troubleshoot.

As shown in FIG. 1, the network blocking unit 4 is connected to the network equipment N. The network equipment N can be a router, a firewall or a switch. The network blocking unit 4 controls the network equipment N to block the violated endpoint devices from network communication with the network environment. For example, when the endpoint device E1 is added to the violation list, the network blocking unit 4 could block its outward connection so it could only be connected to the company-wide intranet to avoid attacks from outside on the weakness of the endpoint device E1 and enhance the security of all endpoint devices E1, E2, E3. It goes without saying that the way for the network blocking unit 4 to block the network can also be such as blocking all connection or blocking all connection except devices in a white list, which also can enhance the security of all endpoint devices E1, E2, E3.

The above description should be considered as only the discussion of the preferred embodiments of the present invention. However, a person having ordinary skill in the art may make various modifications without deviating from the present invention. Those modifications still fall within the scope of the present invention.

What is claimed is:

1. An information security management system that is applied to perform information security managing operation for multiple types of information security software installed in a plurality of endpoint devices existing in a network environment where each endpoint device is installed with at least one type of information security software, wherein one type of the information security software is correspondingly managed and controlled by one third-party management console in such a manner that one endpoint device is connected to the third-party management console to which the type of the information security software installed in said one endpoint device corresponds, the information security management system comprising:
a data collecting unit configured to collect information security database data from third-party software databases of the plurality of third-party management consoles, wherein the information security database data includes endpoint device address data and information security software data of the endpoint device to which the third-party management console connect;
an integrating analyzing unit connecting to the data collection unit, the integrating analyzing unit being configured to integrate the information security information security database data to create an integrated management list, the integrated management list containing the endpoint device address data and the information security software data;
a regulation inspecting unit connecting to the integrating analyzing unit, the regulation inspecting unit being configured to inspect whether the information security software data of each endpoint devices in the integrated management list is in conformity with a predetermined information security policy, and accordingly create a violation list containing the endpoint device address data of the endpoint device not in conformity with the predetermined information security policy; and
a network blocking unit connecting to the regulation inspecting unit, the network blocking unit being configured to corresponding block the endpoint device from the network environment according to the endpoint device address data in the violation list.

2. The information security management system of claim 1, wherein the violation list comprises violation time period data, and the network blocking unit applies a network blocking mode according to the violation time period data to block the corresponding endpoint device from network communication with the network environment.

3. The information security management system of claim 1, wherein the network blocking unit immediately and correspondingly blocks the endpoint device from network communication with the network environment according to the endpoint device address data in the violation list.

4. The information security management system of claim 2, wherein the network blocking mode comprises a permanent blocking mode and an interference blocking mode.

5. The information security management system of claim 1, wherein the regulation inspecting unit periodically inspects to confirm whether each endpoint device in the integrated management list is in conformity with the predetermined information security policy.

6. The information security management system of claim 4, wherein the network blocking unit blocks the endpoint device from network communication with the network environment for a blocking time period which is shorter than an block-inspecting time interval between two periodic block inspecting operations applied to the endpoint device in the violation list performed by the network blocking unit.

7. The information security management system of claim 1, wherein the endpoint device address data comprises an IP address and/or a MAC address.

8. The information security management system of claim 1, wherein the information security software data comprises information security software version data, the regulation inspecting unit inspects the information security software version data to confirm whether the information security software version data is in conformity with the information security policy.

9. An information security management system that is applied to perform information security managing operation for multiple types of information security software installed in a plurality of endpoint devices existing in a network environment where each endpoint device is installed with at least one type of information security software, wherein one type of the information security software is correspondingly managed and controlled by one third-party management console in such a manner that one endpoint device is connected to the third-party management console to which the type of the information security software installed in said one endpoint device corresponds, the information security management system comprising:
a data collecting circuit configured to collect information security database data from third-party software databases of the plurality of third-party management consoles, wherein the information security database data includes endpoint device address data and information security software data of the endpoint device to which the third-party management console connect;
an integrating analyzing circuit connecting to the data collection circuit, the integrating analyzing circuit being configured to integrate the information security information security database data to create an integrated management list, the integrated management list containing the endpoint device address data and the information security software data;
a regulation inspecting circuit connecting to the integrating analyzing circuit, the regulation inspecting circuit being configured to inspect whether the information security software data of each endpoint devices in the integrated management list is in conformity with a predetermined information security policy, and accordingly create a violation list containing the endpoint device address data of the endpoint device not in conformity with the predetermined information security policy; and
a network blocking circuit connecting to the regulation inspecting circuit, the network blocking circuit being configured to corresponding block the endpoint device from the network environment according to the endpoint device address data in the violation list.

10. The information security management system of claim 9, wherein the violation list comprises violation time period data, and the network blocking circuit applies a network blocking mode according to the violation time period data to block the corresponding endpoint device from network communication with the network environment.

11. The information security management system of claim 9, wherein the network blocking circuit immediately and correspondingly blocks the endpoint device from network communication with the network environment according to the endpoint device address data in the violation list.

12. The information security management system of claim 10, wherein the network blocking mode comprises a permanent blocking mode and an interference blocking mode.

13. The information security management system of claim 9, wherein the regulation inspecting circuit periodically inspects to confirm whether each endpoint device in the integrated management list is in conformity with the predetermined information security policy.

14. The information security management system of claim 12, wherein the network blocking circuit blocks the endpoint device from network communication with the network environment for a blocking time period which is shorter than an block-inspecting time interval between two periodic block inspecting operations applied to the endpoint device in the violation list performed by the network blocking circuit.

15. The information security management system of claim 9, wherein the endpoint device address data comprises an IP address and/or a MAC address.

16. The information security management system of claim 9, wherein the information security software data comprises information security software version data, the regulation inspecting circuit inspects the information security software version data to confirm whether the information security software version data is in conformity with the information security policy.
